(19) United States
(12) Patent Application Publication
(10) Pub. No.: US 2018/0372110 A1
(43) Pub. Date: Dec. 27, 2018

(54) AXIAL FLOW FAN

(71) Applicant: BorgWarner Inc., Auburn Hills, MI (US)

(72) Inventors: Tobias MOSER, lmmenstaad (DE); Frank Michael HAASE, Markdorf (DE)

(21) Appl. No.: 16/015,308

(22) Filed: Jun. 22, 2018

(30) Foreign Application Priority Data
Jun. 23, 2017 (DE) 102017210629.8

(51) Int. Cl. F04D 25/08; F04D 19/00; F04D 25/06; F04D 29/32; F04D 29/58; H02K 9/06

(52) U.S. Cl. CPC F04D 25/082; F04D 19/002; H02K 9/06; F04D 29/329; F04D 29/5806; F04D 25/0613

(57) ABSTRACT

The invention relates to an axial flow fan (1) comprising a fan wheel (2) which has a plurality of primary fan blades (3) which are arranged between an inner fan wheel hub (4) and an outer collar (5); and comprising a fan drive (6), which is arranged in the inner hub (4) and which cooperates with a drive electronics arrangement (7) arranged in a stationary outer hub (4), characterized in that a radial flow fan (8) is integrated in the inner hub (4) for generating a cooling air flow for the fan drive (6) and/or the drive electronics arrangement (7).

### CROSS-REFERENCE TO RELATED APPLICATIONS

This application claims the benefit of German Patent Application No. 102017210629.8 filed Jun. 23, 2017, the disclosure of which is herein incorporated by reference in its entirety.

### DESCRIPTION

The invention relates to an axial flow fan according to the preamble of Claim 1.

In a fan of this type, a fan drive is provided which cooperates with a drive electronics arrangement that responds to the respective operating conditions and controls the fan drive so that the desired fan output is achievable.

Since the drive electronics arrangement is arranged within the hub of the axial flow fan, temperature states may occur which in an extreme case may damage the electronics arrangement.

It is therefore the object of the present invention to create an axial flow fan of the type indicated in the preamble of Claim 1, which enables an improved cooling within the hub, particularly of the drive electronics arrangement.

The solution to this problem is carried out by the features of Claim 1.

Correspondingly, in the case of an axial flow fan, comprising a fan wheel and a fan drive, which cooperates with a drive electronics arrangement, a radial flow fan is provided, integrated in the hub, which makes it possible to generate a targeted cooling air flow for the fan drive and/or for the drive electronics arrangement, which extends in a targeted way within the hub or the housing of the axial flow fan and thus achieves an improved cooling in a targeted and efficient way, in particular of the drive electronics arrangement and/or the fan drive.

A ventilator is known from DE 44 41 649 B4 which is provided with slot-like recesses in its hub that represent air passage openings and are to act as a radial fan wheel, wherein these slot-like recesses exclusively form outlet openings to guide a cooling air flow from an electric motor out of the hub to the outside over the shortest path. Therefore, these slot-like recesses do not represent a radial flow fan which would be suitable for generating a cooling air flow.

The subclaims contain as subject matter advantageous refinements of the invention.

The radial flow fan preferably has radial fan blades, which may be arranged and fixed on the hub to generate the cooling air flow.

It is additionally provided that a defined flow path is achievable for the cooling air flow due to the radial flow fan and preferably due to the geometry of the hub or of the housing of the axial flow fan.

It is herein particularly preferred if this flow path may be directed across cooling ribs for the drive electronics arrangement.

Furthermore, the advantage arises that the radial flow fan may form a stiffening arrangement for the entire area of the fan wheel hub of the axial flow fan.

The fan drive is preferably designed as an electric motor, which has a stator which is surrounded on the outer side by a rotor.

It is hereby particularly preferred that the stator is designed such that it forms a housing for the radial flow fan.

In another particularly preferred embodiment, the housing formed by the stator forms a heat sink for the drive electronics arrangement. The stator is encapsulated by a plastic coating for this purpose in a particularly preferred embodiment.

Additional details, advantages, and features of the present invention arise from the subsequent description of an embodiment by way of the drawings. As shown in:

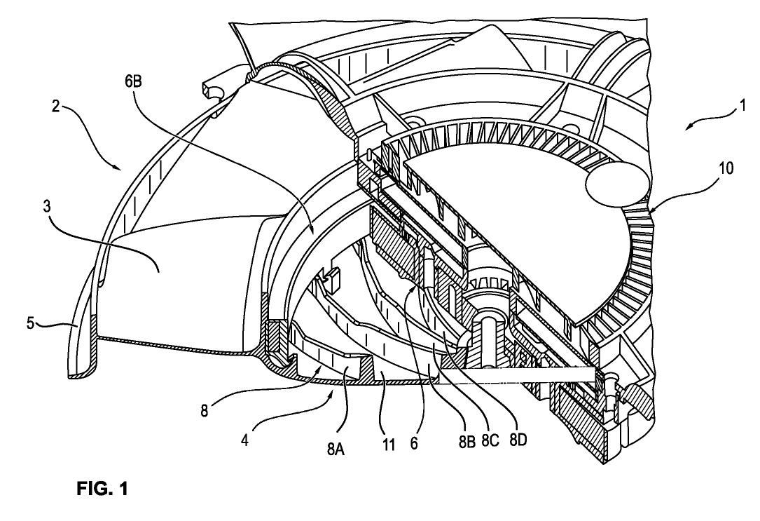

FIG. 1 a partial cutaway perspective of an axial flow fan according to the invention,

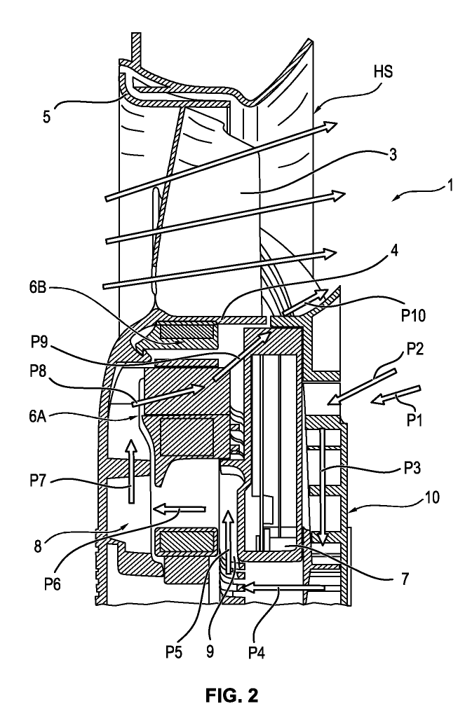

FIG. 2 a partial cross section through the axial flow fan according to FIG. 1, and

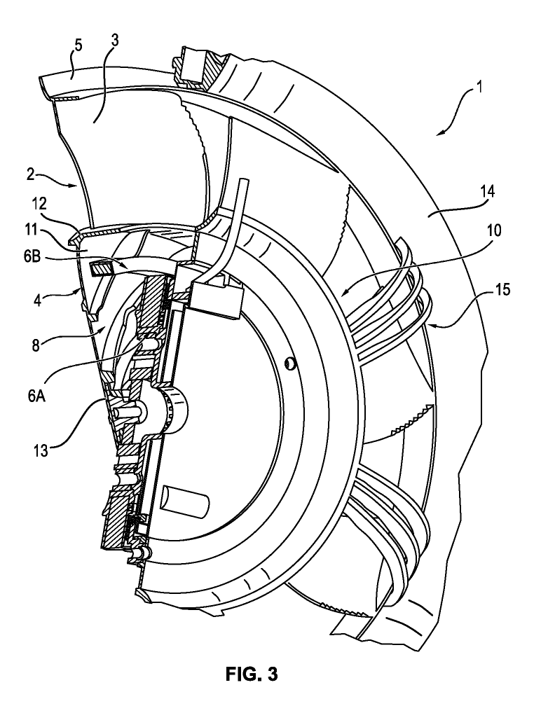

FIG. 3 another partial depiction of the axial flow fan according to the invention from FIG. 1.

The design of an axial flow fan 1 according to the invention arises from an overview of FIGS. 1 through 3 and comprises a fan wheel 2, which has a plurality of primary fan blades 3, of which one fan wheel is designated with reference numeral 3 in FIGS. 1 through 3 respectively.

As is clear from FIGS. 1 through 3, primary fan blades 3 are arranged between an inner hub 4 and a collar 5 which radially surrounds primary fan blades 3 on their outer periphery, wherein primary fan blades 3 are connected both to hub 4 and also to collar 5.

Axial flow fan 1, depicted in FIGS. 1 through 3, has a fan drive 6, which is designed as an electric motor 6 in the particularly preferred embodiment provided here. Fan drive 6 is hereby integrated in hub 4 and cooperates with a drive electronics arrangement 7, likewise integrated in hub 4, which is clear from the depiction in FIGS. 2 and 3.

As explained at the outset, axial flow fan 1 according to the invention has a radial flow fan 8, which generates a cooling air flow for cooling the drive electronics arrangement and/or fan drive 6 and is integrated in hub 4. Radial flow fan 8 has a plurality of radial fan blades which are fixed on a base plate 11 of hub 4 and radial fan blades 8A-8D are visible in FIG. 1. The number of radial fan blades of radial flow fan 8 may be adjusted to the respective application, wherein the radial fan blades of radial flow fan 8 are naturally arranged about the entire circumference of hub 4.

It is particularly clear from FIG. 2 that fan drive 6, designed as an electric motor, is provided with a stator 6A, which is surrounded on the outer side by a rotor 6B.

An arrangement of cooling ribs 9 is provided between drive electronics arrangement 7 and fan drive 6 according to the depiction from FIG. 2.

As is primarily indicated in FIG. 2, it is also possible to form a defined flow path within hubs 4 and 10 for the cooling air flow, which is depicted in FIG. 2 by arrows P1-P10, wherein arrows P1 and P2 illustrate the inlet flow area and arrow P10 illustrates the outlet flow area, whereas arrows P3-P9 illustrate the flow path within an outer hub 10 and inner hub 4, which is preferably designed such that an optimized cooling is possible for drive electronics arrangement 7 and, in the particularly preferred embodiment shown, also for fan drive 6. As FIG. 2 additionally shows, the cooling air flow extends in the particularly preferred embodiment across cooling rib arrangement 9, which is symbolized by arrow P5.

In FIG. 3, axial flow fan 1 according to the invention is reproduced again in an enlarged view. FIG. 3 illustrates that outer stationary hub 10 is connected to a stationary frame 14 surrounding collar 5 on the outer peripheral side via connecting struts, of which an arrangement of three is designated with reference numeral 15.

FIG. 3 additionally illustrates that inner hub 4 is designed as pot shaped and has a base plate 11, which is surrounded on the outer peripheral side by an outer hub ring 12. An inner hub ring 13 is provided on the inner periphery. FIG. 3 additionally illustrates that the radial fan blades of radial flow fan 8 are designed as curved and extend, corresponding to their curvature, from inner hub ring 13 up to outer hub ring 12, wherein the curvature of the radial fan blades is adaptable to the respective application. FIG. 3 additionally shows that the radial fan blades are arranged on base plate 11 of inner rotatable hub 4.

Finally, FIG. 3 illustrates that the arrangement of rotor 6B, which is connected to inner hub 4, has the result that, during a rotation of rotor 6B, the inner hub also rotates with this, and correspondingly both primary fan blades 3 of fan wheel 2 and also the radial fan blades of radial flow fan 8 rotate with this, and by this means generate cooling air flow P1 through P10, as illustrated in FIG. 2, and also primary flow HS (illustrated by three arrows).

In FIG. 2, arrows P2 and P3 symbolize an inlet flow path in outer hub 10 and arrow P4 symbolizes a transition path in hub 10 to inner hub 4. Subsequent arrows P5, P6, P7, P8, and P9 symbolize the through flow path across cooling rib arrangement 9 and through hub 4 up to flow outlet P10.

In addition to the preceding written disclosure of the invention, reference is hereby explicitly made to the graphic representation of the invention in FIGS. 1 through 3 as a supplemental disclosure of the invention.

### REFERENCE SIGN LIST

1 Axial flow fan
2 Fan wheel
3 Primary fan blades
4 Hub
5 Collar
6 Fan drive
6A Stator
6B Rotor
7 Drive electronics arrangement
8 Radial flow fan
8A-8D Curved radial fan blades
9 Cooling ribs/cooling rib arrangement
10 Outer, stationary hub
11 Base plate
12 Outer hub ring
13 Inner hub ring
14 Frame
15 Connecting struts
P1-P10 Flow path or cooling air flow

1. An axial flow fan (1)
comprising a fan wheel (2) which has a plurality of primary fan blades (3) which are arranged between an inner fan wheel hub (4) and an outer collar (5); and
comprising a fan drive (6), which cooperates with a drive electronics arrangement (7) arranged in a stationary outer hub (10), characterized in that
a radial flow fan (8) is integrated in the inner hub (4) for generating a cooling air flow for the fan drive (6) and/or the drive electronics arrangement (7).

2. The axial flow fan according to claim 1, characterized in that the radial flow fan (8) has radial fan blades (8A-8D) that are fixed on the inner hub (4).

3. The axial flow fan according to claim 1, characterized in that a flow path (P1-P10) for the cooling air flow is defined in the outer and inner hub (10, 4).

4. The axial flow fan according to claim 3, characterized in that the flow path (P1-P10) extends across cooling ribs (9) of the drive electronics arrangement (7).

5. The axial flow fan according to claim 1, characterized in that the radial flow fan (8) forms a stiffening arrangement for the inner hub (4).

6. The axial flow fan according to claim 1, characterized in that the fan drive (6) is designed as an electric motor which has a stator (6A), which is surrounded on the outer side by a rotor (6B).

7. The axial flow fan according to claim 6, characterized in that the stator (6A) forms a housing for the radial flow fan (8).

8. The axial flow fan according to claim 3, characterized in that the flow path for the cooling air flow comprises an inlet and transition section (P2, P3, or P4) in the outer hub (10) and a flow section (P5 through P9) in the inner hub (4).

9. The axial flow fan according to claim 7, characterized in that the housing formed by stator (6A) forms a heat sink for the drive electronics (7).

10. The axial flow fan according to claim 6, characterized in that the stator (6A) is encapsulated with a plastic coating.
